(19) United States
(12) Patent Application Publication
(10) Pub. No.: US 2014/0238718 A1
(43) Pub. Date: Aug. 28, 2014

(54) PROTECTIVE ARMOR FOR CABLING

(71) Applicant: General Cable Technologies Corporation, Highland Heights, KY (US)

(72) Inventor: Tim H. TANNER, Union, KY (US)

(73) Assignee: General Cable Technologies Corporation, Highland Heights, KY (US)

(21) Appl. No.: 13/775,767

(22) Filed: Feb. 25, 2013

(51) Int. Cl. H01B 7/18; B32B 3/06; B32B 15/01

(52) U.S. Cl. CPC H01B 7/18; B32B 15/013; B32B 3/06
USPC 174/102 R; 428/591

(57) ABSTRACT

A protective armor layer that comprises a plurality of overlapping reinforcement strips. Each reinforcement strip includes a first end that has a substantially semi-circular profile, a second end opposite the first end that has a linear angular extension, and a substantially flat segment between the first and second ends. The substantially semi-circular profile of the first end defines an area configured to receive the linear angular extension of the second end of an adjacent reinforcement strip, such that the first end of the reinforcement strip extends about halfway across the substantially flat segment of the adjacent reinforcement strip.

### FIELD OF THE INVENTION

The present application relates to protective armor for cabling. More specifically, the protective armor has a substantially half round profile and can be used on a flat or round cable construction, such as an electric submersible pump cable.

### BACKGROUND OF THE INVENTION

An electric submersible pump is a pump which is designed to be submerged in a fluid. Unlike standard jet pumps which typically pull fluid from a well or other area situated below the pump, electric submersible pumps are submerged in the fluid and push it to a surface at a higher elevation. Electric submersible pumps are advantageous for use in oil wells, as they can operate at fairly low depths and provide for greater efficiency than standard jet pumps. Some electric submersible pumps operate in wells at depths of 7,000-12,000 feet. They can also be used in a variety of other applications, such as sewage treatment plants, seawater handling, groundwater piping, deep well drilling, irrigations systems, and the like.

Because these pumps are submerged in fluids at low depths, special cables are needed to be able to withstand the extreme conditions (i.e., high pressure and corrosivity). Thus, the cable must be durable and well protected from the elements. Most cables used in connection with electric submersible pumps are typically covered in a protective sheath to provide impact and crush resistance. The profiles of conventional protective sheaths often have insufficient mechanical strength.

Therefore, a protective sheath which provides for better mechanical properties, but which can also be used on a flat or round cable construction, is needed.

### SUMMARY OF THE INVENTION

Accordingly, an exemplary embodiment of the present invention provides a protective armor layer that comprises a plurality of overlapping reinforcement strips. Each reinforcement strip includes a first end that has a substantially semi-circular profile, a second end opposite the first end that has a linear angular extension, and a substantially flat segment between the first and second ends. The substantially semi-circular profile of the first end defines an area configured to receive the linear angular extension of the second end of an adjacent reinforcement strip, such that the first end of the reinforcement strip extends about halfway across the substantially flat segment of the adjacent reinforcement strip.

The present invention may also provide an armored cable for an electric submersible pump that comprises at least one conductor and a protective armor layer wrapped helically around the conductor. The protective armor layer includes a plurality of overlapping reinforcement strips. Each reinforcement strip includes a first end that has a substantially semi-circular profile, a second end opposite the first end that has a linear angular extension, and a substantially flat segment between the first and second ends. The substantially semi-circular profile of the first end defines an area configured to receive the linear angular extension of the second end of an adjacent reinforcement strip, such that the first end of the reinforcement strip extends about halfway across the substantially flat segment of the adjacent reinforcement strip.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an elevational view of a cable with a half round armor profile in accordance with an exemplary embodiment of the present invention;

FIG. 2A is a cross-sectional end view of the cable illustrated in FIG. 1;

FIG. 2B is a cross-sectional side view of the cable taken along line 2B-2B of FIG. 2A; and

FIG. 3 is a side elevational view of a segment of the half round armor profile of the cable illustrated in FIGS. 2A and 2B.

### DETAILED DESCRIPTION OF THE EXEMPLARY EMBODIMENTS

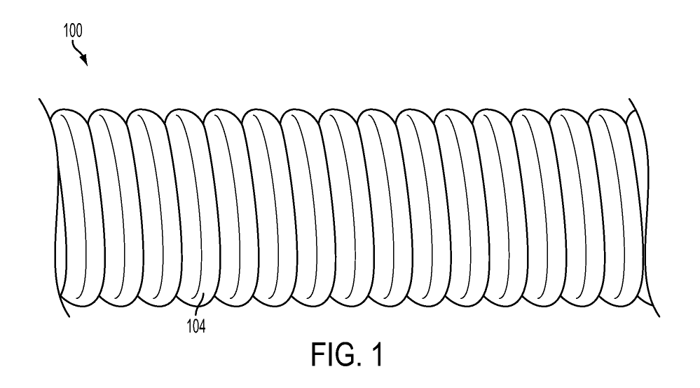

Referring to FIGS. 1, 2A, 2B and 3, the cable 100 of the present invention generally comprises at least one conductor 102 and a protective armor layer 104. The protective armor layer 104 comprises a plurality of overlapping reinforcement strips 106. The protective armor layer 104 may be wrapped helically around the conductor(s) to provide optimal impact resistance to the cable 100.

As shown in FIG. 3, each of the reinforcement strips 106 may have three main segments 108, 112 and 116. The first end 108 of each reinforcement strip 106 preferably has a substantially semi-circular profile 110. This semi-circular or “half round” profile 110 (half round refers to the entirety of the strip 106 profile, being that approximately half of it is round) provides for better impact resistance of the cable 100 because the rounded shape of the first end 108 provides greater resistance to compressive stresses than that of a flat profile.

The second end 112 of each reinforcement strip 106 opposite the first end 108 preferably has a linear angular extension 114. Each reinforcement strip 106 may also have a substantially flat segment 116 between the first end 108 and the second end 112. The linear angular extension 114 of the second end 112 extends outwardly, roughly 30° relative to the substantially flat segment. Both the first end 108 and second end 112 of each reinforcement strip 106 extend outwardly in the same direction (i.e., away from the conductors 102), relative to the substantially flat segment 116. The first end 108 and the substantially flat segment 116 preferably have similar lengths, while the linear angular extension 114 of the second end 112 is preferably shorter in length than the first end 108 or the substantially flat segment 116 of each reinforcement strip 106.

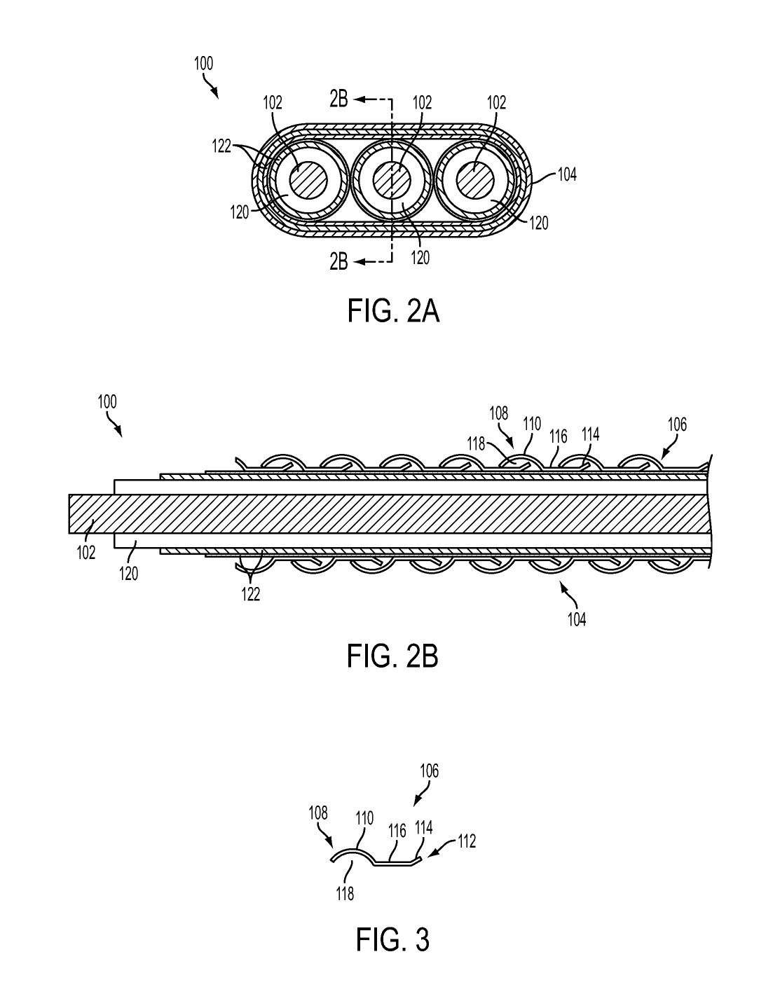

As shown in FIG. 2B, when overlapping, the substantially semi-circular profile 110 of the first end 108 of each strip 106 defines an area 118 configured to receive the linear angular extension 114 of the second end 112 of an adjacent reinforcement strip 106. The first end 108 of each strip 106 preferably extends about halfway across the substantially flat segment 116 of the adjacent reinforcement strip 106. The linear angular extension 114 of each reinforcement strip 106 extends into the area 118 of the first end 108, such that adjacent reinforcement strips interlock to form a protective armor layer 104. The strips generally interlock by virtue of the upward angle of section 114 in conjunction with the downward angle of section 110. The strips stay in their overlapped formation by virtue of the forming of the metal and the process of wrapping the armor around the underlying cable. Thus, the linear angular extension 114 is preferably sized such that it is shorter than the radius of the semi-circular profile 110, so that it is able to fit within the area 118 defined by the semi-circular profile 110. The first end 108 of each strip 106 preferably does not make contact with the linear angular extension 114 of the adjacent reinforcement strip 106, but instead extends above it and across the substantially flat segment 116 of the same adjacent reinforcement strip 106, making contact therewith. However, upon bending the cable along its minor axis, it may be that the first end of 108 will come in contact with 114 of adjacent strip 106 on the outside of the bend and in contact with 110 of adjacent strip 106 on the inside of the bend.

According to one exemplary embodiment, the first end 108 may have a height of about 0.095 inches and a total length of about 0.5 inches. According to another exemplary embodiment, each reinforcement strip 106 may be about 0.015-0.025 inches thick and about 0.5-0.75 inches wide. The reinforcement strips 106 may be formed of any metal material, such as galvanized steel, stainless steel, nickel-copper alloy, and the like. Galvanized steel exhibits acceptable mechanical strength and is relatively inexpensive. Stainless steel and nickel-copper alloys are more expensive, but also exhibit improved mechanical properties suitable for use in more aggressive environments.

As shown in FIGS. 2A and 2B, the protective armor layer 104 is wrapped helically around at least one conductor 102 to form the assembled cable 100. According to one embodiment, the conductor(s) 102 are 1 AWG-6 AWG in size and are made of copper. In a preferred embodiment, the protective armor layer 104 wraps around at least three conductors 102. The three conductors 102 may have a parallel configuration, also known as a “flat construction.” An insulation layer 120 may also be wrapped around each individual conductor 102 of the cable 100. The insulation layer 120 may be, for example, a synthetic rubber such as ethylene propylene diene monomer (EPDM) rubber, to insulate the conductors 102. Other materials which may be used as insulation include, but are not limited to, cross-linked polyethylene (XLPE), polyvinyl chloride (PVC), polytetrafluoroethylene (PTFE), polypropylene (PP), fluorinated ethylene propylene (PEP), and polyether ether ketone (PEEK), and the like. The conductors 102 may be further insulated by electrical tapes, such as polyimide tape, or other barrier layers 122 known to one skilled in the art. The assembled cable may also comprise one or more capillary tubes (not shown), which may be used to deliver chemical treatments to a well. The capillary tubes are kept insulated from the conductors 102, but are incorporated within the cable 100 in order to eliminate the cost of having to run separate chemical treatment lines.

To confirm the crush resistance of the protective armor of the present invention, two groups of exemplary cables were tested. In the first group, nine ESP cables having a flat construction with conventional flat armor were provided. In the second group, eleven ESP cables having a flat construction with the half-round profile of the present invention were provided. Those groups of cables were then subjected to impact testing, the results of which are shown in Table 1 below. An exemplary impact testing procedure includes a steel impact torpedo (approximately 3 inches in diameter with an approximately 3 inches diameter hemispherical impact head) is elevated inside of a guide tube and released and allowed to drop freely (approximately 96 inches) and impact the test specimen placed inside the impact zone. Those steps are repeated about 10 times in the impact testing.

In particular, the areas of impact of each tested cable were cut with a metal band saw to expose a cross-section of the middle copper conductor at the impact point. The horizontal width and vertical height of the cross-sectional face of the copper conductor was measured in order to determine how severely the cable had been flattened under the impact weight. Because the copper conductors initially have circular cross-sectional shape, their initial width and height measurements are substantially equal. When flattened, the conductor width increases while the conductor height decreases.

As shown in Table 1, the conductors of the exemplary cables having the half-round armor of the present invention were flattened less than those having the conventional flat armor, as exhibited by their lower average width and higher average height. The copper conductors of the exemplary cables having the conventional flat profile were more severely flattened during impact testing.

TABLE 1
Cross-sectional measurement of middle copper conductor

| | Cross-sectional Width (mils) | | Cross-sectional Height (mils) | |
|---|---|---|---|---|
| | Round armor | Flat armor | Round armor | Flat armor |
| Cable 1 | 254 | 269 | 194 | 197 |
| Cable 2 | 249 | 256 | 170 | 168 |
| Cable 3 | 255 | 258 | 191 | 195 |
| Cable 4 | 246 | 261 | 191 | 158 |
| Cable 5 | 249 | 251 | 187 | 187 |
| Cable 6 | 252 | 246 | 207 | 177 |
| Cable 7 | 249 | 249 | 176 | 205 |
| Cable 8 | 250 | 260 | 181 | 184 |
| Cable 9 | 245 | 261 | 189 | 164 |
| Cable 10 | 252 | — | 178 | — |
| Cable 11 | 245 | — | 175 | — |
| Average | 249.6 | 256.8 | 185.4 | 181.7 |
| St. Dev. | 3.4 | 7.1 | 10.6 | 16.1 |

Although the conductor insulation was compromised on all samples observed, the conductor insulation of all of the conventional flat armor cables was damaged on both flattened sides of the conductor. In contrast, only 3 out of 11 half-round armor cables of the present invention had insulation damage on both sides. In the remaining 8 half-round armor cables, only one side of the conductor insulation was damaged while the other side remained intact. Thus, the half-round armor cables of the present invention exhibited less flattening and less damage to the conductor insulation layers as compared to the conventional flat armor cables, thereby providing better impact resistance.

While particular embodiments have been chosen to illustrate the invention, it will be understood by those skilled in the art that various changes and modifications can be made therein without departing from the scope of the invention as defined in the appended claims.

What is claimed is:

1. A protective armor layer, comprising:
a plurality of overlapping reinforcement strips, each of said plurality of reinforcement strips including a first end having a substantially semi-circular profile, a second end opposite said first end having a linear angular extension, and a substantially flat segment between said first end and said second end,
wherein said substantially semi-circular profile of said first end of one reinforcement strip of said plurality of reinforcement strips defines an area configured to receive said linear angular extension of said second end of an adjacent reinforcement strip of said plurality of reinforcement strips, such that said first end of said reinforcement strip extends about halfway across said substantially flat segment of said adjacent reinforcement strip.

2. A protective armor layer according to claim 1, wherein
said substantially semi-circular profile of said first end of each of said plurality of reinforcement strips and said linear angular extension of said second end of each of said plurality of reinforcement strips extend outwardly relative to said substantially flat segment.

3. A protective armor layer according to claim 1, wherein
said linear angular extension of said second end of each of said plurality of reinforcement strips is shorter than said first end or said substantially flat segment of each of said plurality of reinforcement strips.

4. A protective armor layer according to claim 1, wherein
said first end and said substantially flat segment of said plurality of reinforcement strips have a similar length.

5. A protective armor layer according to claim 1, wherein
said plurality of reinforcement strips are formed of a material, selected from the group consisting of galvanized steel, stainless steel, and nickel-copper alloy.

6. A protective armor layer according to claim 1, wherein
each of said plurality of reinforcement strips are about 0.5 inches in length; and
each of said first ends of said plurality of reinforcement strips has a height of about 0.095 inches.

7. A protective armor layer according to claim 1, wherein
each of said plurality of reinforcement strips is about 0.015-0.025 inches thick; and
each of said plurality of reinforcement strips is about 0.5-0.75 inches wide.

8. An armored cable for an electric submersible pump, comprising:
at least one conductor;
a protective armor layer wrapped helically around said at least one conductor, said protective armor layer including,
a plurality of overlapping reinforcement strips, each of said plurality of reinforcement strips including a first end having a substantially semi-circular profile, a second end opposite said first end having a linear angular extension, and a substantially flat segment between said first end and said second end,
wherein said substantially semi-circular profile of said first end of one reinforcement strip of said plurality of reinforcement strips defines an area configured to receive said linear angular extension of said second end of an adjacent reinforcement strip of said plurality of reinforcement strips, such that said first end of said reinforcement strip extends about halfway across said substantially flat segment of said adjacent reinforcement strip.

9. An armored cable for an electric submersible pump according to claim 8,
said substantially semi-circular profile of said first end of each of said plurality of reinforcement strips and said linear angular extension of said second end of each of said plurality of reinforcement strips extend outwardly relative to said substantially flat segment.

10. An armored cable for an electric submersible pump according to claim 8, wherein
said linear angular extension of said second end of each of said plurality of reinforcement strips is shorter than said first end or said substantially flat segment of each of said plurality of reinforcement strips.

11. An armored cable for an electric submersible pump according to claim 8, wherein,
said first end and said substantially flat segment of said plurality of reinforcement strips have a similar length.

12. An armored cable for an electric submersible pump according to claim 8, wherein
said at least one conductor is made of copper.

13. An armored cable for an electric submersible pump according to claim 8, wherein
said at least one conductor is 1 AWG-6 AWG in size.

14. An armored cable for an electric submersible pump according to claim 8, further comprising
an insulation layer wrapped around said at least one conductor.

15. An armored cable for an electric submersible pump according to claim 8, further comprising at least three conductors.

16. An armored cable for an electric submersible pump according to claim 15, wherein
said protective armor layer is wrapped around said at least three conductors.

17. An armored cable for an electric submersible pump according to claim 16, wherein
said at least three conductors have a parallel configuration.

18. An armored cable for an electric submersible pump according to claim 8, wherein
said plurality of reinforcement strips are formed of a material, selected from the group consisting of galvanized steel, stainless steel, and nickel-copper alloy.

19. An armored cable for an electric submersible pump according to claim 8, wherein
each of said plurality of reinforcement strips are about 0.5-0.75 inches in length; and
each of said first ends of said plurality of reinforcement strips has a height of about 0.095 inches.

20. An armored cable for an electric submersible pump according to claim 8, wherein
each of said plurality of reinforcement strips is about 0.015-0.025 inches thick; and
each of said plurality of reinforcement strips is about 0.5-0.75 inches wide.
